(19) United States
(12) Patent Application Publication
(10) Pub. No.: US 2015/0271131 A1
(43) Pub. Date: Sep. 24, 2015

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD, Tokyo (JP)

(72) Inventor: Tomoka NAKAGAWA, Kanagawa (JP)

(73) Assignee: FUJI XEROX CO., LTD, Tokyo (JP)

(21) Appl. No.: 14/472,729

(22) Filed: Aug. 29, 2014

(30) Foreign Application Priority Data
Mar. 20, 2014 (JP) 2014-059124

(51) Int. Cl. H04L 29/12; H04L 12/24

(52) U.S. Cl. CPC H04L 61/2061; H04L 41/082; H04L 61/1505

(57) ABSTRACT

An information processing apparatus includes an acquiring unit, a creating unit, and a requesting unit. The acquiring unit acquires a first communication address to be assigned to a first communication interface. The creating unit creates, in a case where a second communication address that has already been assigned to a second communication interface is the same as the first communication address, an alternative first communication address, which is different from the first communication address. The requesting unit requests assigning of the alternative first communication address to the first communication interface.

### CROSS-REFERENCE TO RELATED APPLICATIONS

This application is based on and claims priority under 35 USC 119 from Japanese Patent Application No. 2014-059124 filed Mar. 20, 2014.

### BACKGROUND

### Technical Field

The present invention relates to an information processing apparatus, an information processing method, and a non-transitory computer readable medium.

### SUMMARY

According to an aspect of the invention, there is provided an information processing apparatus including an acquiring unit, a creating unit, and a requesting unit. The acquiring unit acquires a first communication address to be assigned to a first communication interface. The creating unit creates, in a case where a second communication address that has already been assigned to a second communication interface is the same as the first communication address, an alternative first communication address, which is different from the first communication address. The requesting unit requests assigning of the alternative first communication address to the first communication interface.

### BRIEF DESCRIPTION OF THE DRAWINGS

An exemplary embodiment of the present invention will be described in detail based on the following figures, wherein:

FIG. 1 is a diagram for describing a hardware configuration of an information processing apparatus and an example of a device connected to the information processing apparatus;

FIG. 2 is a diagram for describing a functional configuration of a controller;

FIG. 3 is a diagram for describing an example of network setting information;

FIG. 4 is a sequence diagram for describing a communication address acquisition process and an update process;

FIG. 5 is a flowchart for describing a process for setting a piece of communication address information; and

FIG. 6 is a diagram for describing an example of a prevention process.

### DETAILED DESCRIPTION

In the following, an exemplary embodiment according to the present invention (hereinafter referred to as an exemplary embodiment) will be described with reference to the drawings.

[1. Hardware Configuration of Information Processing Apparatus]

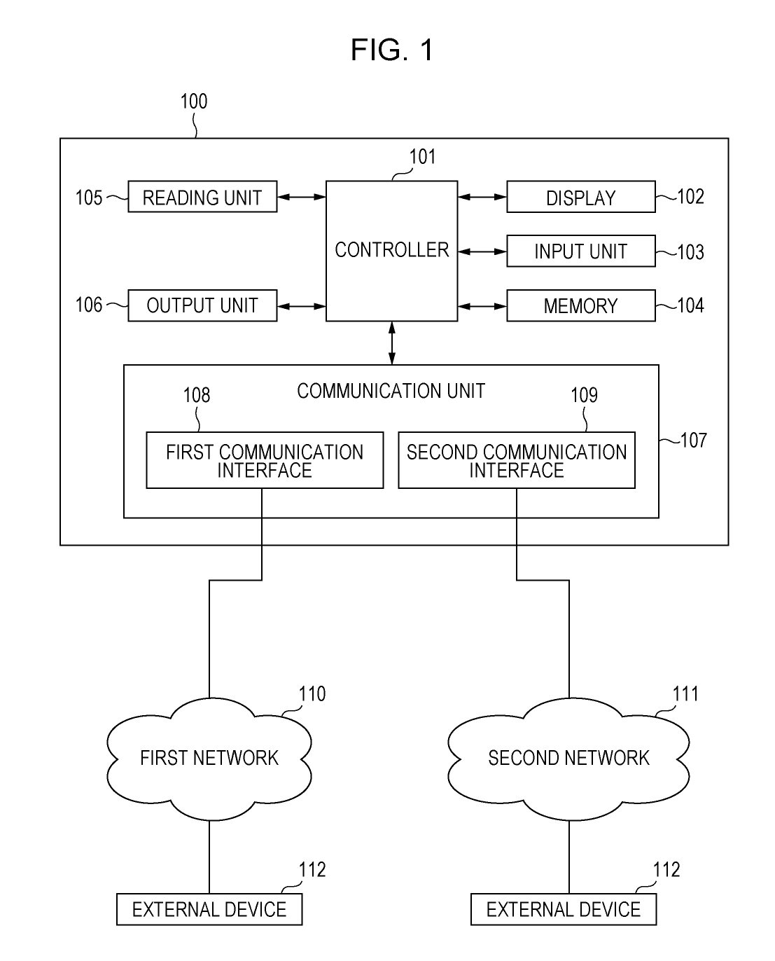

FIG. 1 is a diagram for describing a hardware configuration of an information processing apparatus 100 according to the exemplary embodiment of the invention and an example of a device connected to the information processing apparatus 100. As illustrated in FIG. 1, the information processing apparatus 100 includes a controller 101, a display 102, an input unit 103, a memory 104, a reading unit 105, an output unit 106, and a communication unit 107. The information processing apparatus 100 may also include an operation unit, and a power switch, in addition to the configuration illustrated in FIG. 1.

The controller 101 includes a central processing unit (CPU). The controller 101 executes various types of arithmetic processes and controls individual units of the information processing apparatus 100 in accordance with a program stored in the memory 104. Details of the controller 101 will be described later.

The display 102 is realized by a display device such as a liquid crystal display (LCD), and displays a result (a screen) of information processing performed by the controller 101.

The input unit 103 is realized by an input device such as a touch panel and a button key, and receives an operation input from a user.

The memory 104 includes, for example, an information recording medium such as a read-only memory (ROM), a random-access memory (RAM), and a hard disk. The memory 104 stores a program to be executed by the controller 101. The memory 104 also serves as, for example, a work memory of the controller 101. Note that, as the memory 104, various types of memory are applicable. For example, the memory 104 may be realized by a storage device such as a semiconductor memory. In addition, a program or various types of data, which are described as something stored in the memory 104 in the exemplary embodiment, may also be acquired from an external device 112 via the communication unit 107 or may also be acquired from an external storage medium.

The reading unit 105 includes a scanner. The reading unit 105 reads an image on a target such as a sheet by optically scanning the target.

The output unit 106 includes a printing unit that forms an image on a sheet (a recording medium) such as paper. The output unit 106 prints (outputs) an image based on image data and the like on a sheet such as paper in accordance with control performed by the controller 101.

The communication unit 107 includes plural communication interfaces and performs data communication in a wired or wireless manner with an external device 112 connected to the information processing apparatus 100. For example, as illustrated in FIG. 1, the communication unit 107 includes a first communication interface 108 and a second communication interface 109. Each of the plural communication interfaces includes, for example, a network interface card (NIC).

Note that FIG. 1 illustrates a case where the communication unit 107 includes two communication interfaces; however, the number of interfaces included in the communication unit 107 has only to be at least two and may also be three or more. Each of the plural communication interfaces included in the communication unit 107 may be either a physical interface or a logical interface.

A first network 110 and a second network 111 are, for example, a local-area network (LAN), the Internet, an intranet, a next-generation network (NGN), or the like. The first network 110 and the second network 111 are independent networks and are not connected to each other.

An external device 112 includes a server computer. A server computer has, for example, a Dynamic Host Configuration Protocol (DHCP) function and assigns an Internet Protocol (IP) address in response to a request from the information processing apparatus 100. Note that the external device 112 may also be a mobile terminal, a server computer, or the like. In addition, the number of external devices 112 connected to each of the first and second networks 110 and 111 may be two or more.

[2. Function Realized by Controller]

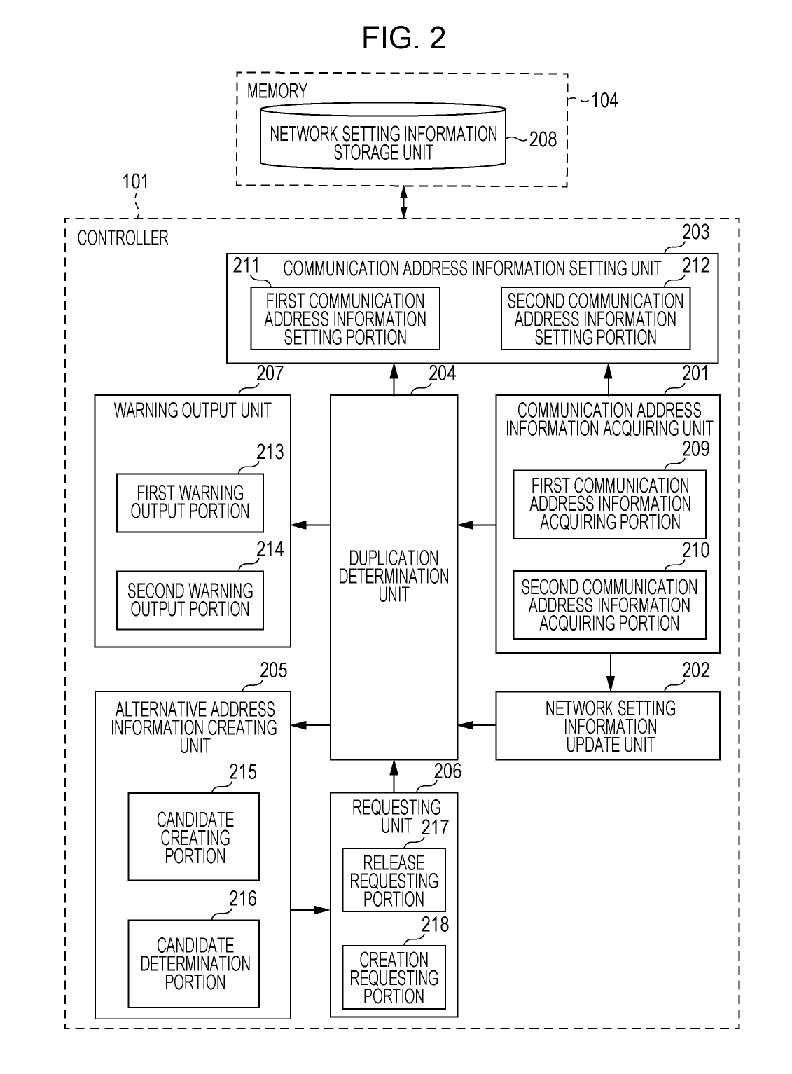

FIG. 2 is a functional block diagram of the information processing apparatus 100. As illustrated in FIG. 2, the controller 101 functionally includes a communication address information acquiring unit 201, a network setting information update unit 202, a communication address information setting unit 203, a duplication determination unit 204, an alternative address information creating unit 205, a requesting unit 206, and a warning output unit 207. In addition, the memory 104 functionally includes a network setting information storage unit 208. The functions illustrated in FIG. 2 are realized by programs executed by the controller 101, the programs being stored in the memory 104.

The communication address information acquiring unit 201 functionally includes communication address information acquiring portions corresponding to respective communication interfaces. Each communication address information acquiring portion acquires a piece of communication address information assigned by a server computer to a communication interface corresponding to the communication address information acquiring portion. Note that pieces of acquired communication address information are stored in the network setting information storage unit 208.

Here, each piece of communication address information is information necessary to perform communication via a network. Specifically, for example, each piece of communication address information includes information of an IP address, information of a subnet mask, and information of a gateway. Note that each piece of communication address information may also include, in addition to the above-described information, information included in a communication protocol to be used when the information processing apparatus 100 and the external device 112 or the like perform communication therebetween.

Specifically, for example, as illustrated in FIG. 2, the communication address information acquiring unit 201 includes a first communication address information acquiring portion 209 and a second communication address information acquiring portion 210. The first communication address information acquiring portion 209 acquires a piece of first communication address information assigned by a server computer to the first communication interface 108. Likewise, the second communication address information acquiring portion 210 acquires a piece of second communication address information assigned by a server computer to the second communication interface 109. Note that in the case where the number of communication interfaces is three or more, the communication address information acquiring unit 201 may be configured to include communication address acquiring portions the number of which corresponds to the number of communication interfaces.

In addition, each communication address information acquiring portion acquires pieces of communication address information in accordance with a communication protocol. Specifically, for example, each communication address information acquiring portion acquires pieces of communication address information in accordance with the DHCP. A detailed example in which a communication address is acquired through the DHCP function will be described later using a flowchart. Note that each communication address information acquiring portion may also acquire each piece of communication address information in accordance with an input done to the input unit 103 or the like. Specifically, for example, each communication address information acquiring portion may also acquire each piece of communication address information in a method that a user manually inputs to the input unit 103 or the like.

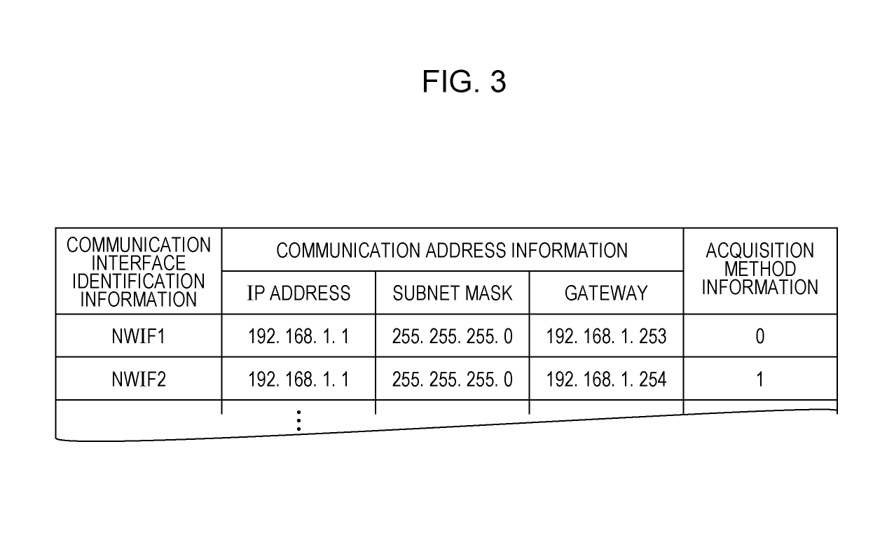

For each piece of communication address information acquired by each communication address information acquisition portion, the network setting information update unit 202 updates network setting information in accordance with the piece of acquired communication address information. Here, network setting information is first described. Network setting information is information to be used when each communication interface communicates with an external device 112 and is information to be stored in the network setting information storage unit 208. Specifically, for example, the network setting information is information as illustrated in FIG. 3.

As illustrated in FIG. 3, the network setting information is information in which communication interface identification information, communication address information, and acquisition method information are associated with each other. The communication interface identification information is information for identifying communication interfaces and is information preset in the memory 104 or the like. For example, as illustrated in the first column of FIG. 3, identification information for identifying the first communication interface 108 is NWIF1 and identification information for identifying the second communication interface 109 is NWIF2, NWIF1 and NWIF2 being pieces of preassigned identification information.

The second, third, and fourth columns of FIG. 3 show information of IP addresses, information of subnet masks, information of gateways, respectively, included in the communication address information. Note that information such as a DNS server address may also be included in addition to the above-described information in the communication address information.

The fifth column of FIG. 3 shows acquisition method information representing a method in which communication address information has been acquired. Acquisition method information is, for each piece of communication address information, information as to whether the piece of communication address information has been acquired in accordance with an input done to the input unit 103 or the like (hereinafter referred to as manual acquisition) or in accordance with a communication protocol (hereinafter referred to as automatic acquisition). Specifically, for example, the acquisition method information is represented by an identifier of “0” when a determination result is automatic acquisition or by an identifier of “1” when a determination result is manual acquisition.

Returning to the description of FIG. 2, a specific example of an operation of the network setting information update unit 202 will be described. For example, in the case where the first communication interface 108 has acquired in accordance with a communication protocol a piece of communication address information including an IP address of “192.168.1.1”, a subnet mask of “255.255.255.0”, and a gateway of “192.168.1.253”, the network setting information update unit 202 updates as illustrated in FIG. 3 the pieces of information: the IP address, the subnet mask, and the gateway; and acquisition method information, which is “0”, in association with the identification information NWIF1.

Likewise, for example, in the case where the second communication interface 109 has acquired in accordance with an input done to the input unit 103 or the like a piece of communication address information including an IP address of “192.168.1.1”, a subnet mask of “255.255.255.0”, and a gateway of “192.168.1.254”, the network setting information update unit 202 updates as illustrated in FIG. 3 the pieces of information: the IP address, the subnet mask, and the gateway; and acquisition method information, which is “1”, in association with the identification information NWIF2.

The duplication determination unit 204 determines, in the case where network setting information is updated and the network setting information includes plural pieces of communication address information, whether or not information included in a piece of updated communication address information is the same as information included in another piece of communication address information included in the network setting information. For example, in the case where a piece of communication address information associated with the identification information NWIF1 has been updated, the duplication determination unit 204 compares an IP address associated with the identification information NWIF1 with an IP address associated with the identification information NWIF2 and determines whether or not these IP addresses are the same.

Specifically, for example, the case will be described where a piece of communication address information associated with the identification information NWIF1 has been updated and the network setting information has been updated to the information as illustrated in FIG. 3. In this case, the duplication determination unit 204 compares an IP address of “192.168.1.1” associated with the identification information NWIF1 with an IP address of “192.168.1.1” associated with the identification information NWIF2. Since the two IP addresses are the same, the duplication determination unit 204 determines that the IP addresses are the same.

The communication address information setting unit 203 functionally includes communication address information setting portions corresponding to respective communication interfaces. Each communication address information setting portion sets each piece of acquired communication address information in the communication interface corresponding to the piece of acquired communication address information.

Specifically, for example, as illustrated in FIG. 2, the communication address information setting unit 203 functionally includes a first communication address information setting portion 211 and a second communication address information setting portion 212. The first communication address information setting portion 211 sets, in the first communication interface 108, information such as an IP address and the like included in a piece of acquired first communication address information. The second communication address information setting portion 212 sets, in the second communication interface 109, information such as an IP address and the like included in a piece of acquired second communication address information. Note that in the case where the number of communication interfaces is three or more, the communication address information setting unit 203 may be configured to include communication address setting portions the number of which corresponds to the number of communication interfaces.

The warning output unit 207 functionally includes a first warning output portion 213 and a second warning output portion 214. The first warning output portion 213 outputs a first warning in the case where a server computer or the like does not assign a piece of communication address information different from a piece of communication address information that has been once assigned. That is, in the case where a piece of communication address information acquired in automatic acquisition is determined to be a piece of duplicate information by the duplication determination unit 204, the first warning output portion 213 outputs a message indicating that the piece of communication address information is the same as another piece of communication address information that has already been set.

Specifically, for example, in the above-described example, in the case where the piece of communication address information has been acquired in accordance with a communication protocol such as the DHCP, the first warning output portion 213 outputs, to the display 102 or the like, a message indicating that an IP address of “192.168.1.1” associated with the identification information NWIF1 is the same as an IP address of “192.168.1.1” associated with the identification information NWIF2.

The second warning output portion 214 outputs a second warning in the case where a piece of communication address information that has already been assigned to a certain communication interface is the same as a piece of communication address information to be assigned to the first communication interface 108 in manual acquisition. That is, in the case where a piece of communication address information acquired in manual acquisition is determined to be a piece of duplicate information by the duplication determination unit 204, the second warning output portion 214 outputs a message indicating that the piece of communication address information is the same as another piece of communication address information that has already been set.

Specifically, for example, in the above-described example, in the case where each piece of communication address information has been acquired in accordance with an input done to the input unit 103 or the like, the second warning output portion 214 outputs, to the display 102 or the like, a message similar to the one described above and indicating that IP addresses are the same.

In the case where a piece of communication address information that has already been assigned to a certain communication interface matches a piece of communication address information that is newly acquired by a certain communication address acquisition portion, the alternative address information creating unit 205 creates a piece of alternative communication address information from candidates for a piece of communication address information (hereinafter referred to as communication address information candidates) other than the piece of newly acquired communication address information.

For example, in the case where a piece of second communication address information that has already been assigned to the second communication interface 109 matches a piece of first communication address information acquired by the first communication address information acquiring portion 209, the alternative address information creating unit 205 creates a piece of alternative first communication address information from communication address information candidates other than the piece of first communication address information. In the following, a function of the alternative address information creating unit 205 will be described. The alternative address information creating unit 205 functionally includes a candidate creating portion 215 and a candidate determination portion 216.

The candidate creating portion 215 creates a candidate for an IP address (hereinafter referred to as an IP address candidate) in accordance with information included in a piece of communication address information acquired from a server computer or the like. That is, the candidate creating portion 215 creates, in accordance with pieces of information included in network setting information and associated with a certain communication interface, an IP address candidate from IP addresses other than the IP address included in the piece of communication address information. For example, the candidate creating portion 215 excludes the above-described IP address and the above-described gateway and creates an IP address candidate including a network address determined by a subnet mask.

Specifically, for example, the case will be described where network setting information acquired from a DHCP server is the information illustrated in FIG. 3. Here, a piece of first communication address information included in the network setting information illustrated in FIG. 3 is a piece of communication address after acquisition from the DHCP server or the like is performed by the first communication address information acquiring portion 209 and before setting is performed by the first communication address information setting portion 211. In this case, network addresses defined by a subnet mask associated with the first communication interface 108 are “192.168.1.0” to “192.168.1.255”. In addition, an IP address and a gateway associated with the first communication interface 108 are “192.168.1.1” and “192.168.1.253”, respectively. Thus, the candidate creating portion 215 creates an IP address candidate from “192.168.1.0”, “192.168.1.2” to “192.168.1.252”, and “192.168.1.255”.

Note that in the case where a piece of communication address information includes information in addition to the above-described pieces of information, the candidate creating portion 215 may also create the above-described IP address in accordance with the information. For example, in the case where a piece of communication address information includes a DNS server address in addition to the above-described pieces of information, the candidate creating portion 215 may also create IP address candidates other than the DNS server address.

The candidate determination portion 216 determines whether or not external devices 112 connected to the same network segment as a certain communication interface include an external device 112 in which an IP address candidate created by the candidate creating portion 215 is set. Specifically, for example, the candidate determination portion 216 determines using Address Resolution Protocol (ARP) whether or not external devices 112 connected to the first network 110 include an external device 112 in which an IP address candidate created by the candidate creating portion 215 is set.

In this case, the candidate determination portion 216 first sends (that is, broadcasts) the IP address candidate created by the candidate creating portion 215 to all the external devices 112 connected to the first network 110. Then, in the case where the external devices 112 include an external device 112 in which the IP address candidate created by the candidate creating portion 215 is set, the external device 112 sends a media access control (MAC) address to the first communication interface 108. The candidate determination portion 216 determines that, in the case where the first communication interface 108 has acquired a MAC address, the IP address candidate created by the candidate creating portion 215 has already been used. In contrast, the candidate determination portion 216 determines that, in the case where the first communication interface 108 does not acquire a MAC address from any external device 112, the IP address candidate created by the candidate creating portion 215 has not yet been used.

The requesting unit 206 functionally includes a release requesting portion 217 and a creation requesting portion 218. The release requesting portion 217 requests a server computer or the like to release an IP address assigned to a certain communication interface. That is, in the case where the alternative address information creating unit 205 has created a piece of alternative communication address information, the release requesting portion 217 requests release of an IP address included in a piece of communication address information that has already been acquired by a certain communication address information acquisition portion. Specifically, for example, the release requesting portion 217 requests release of an IP address included in a piece of first communication address information that has already been acquired, by sending a DHCP release message to a server computer having a DHCP function.

The creation requesting portion 218 requests a server computer or the like to assign, to a certain communication interface, a piece of communication address information including an IP address and created by the alternative address information creating unit 205. Specifically, for example, the creation requesting portion 218 sends a DHCP message including information of an IP address to a server computer. By sending the DHCP message, the creation requesting portion 218 requests the server computer to assign an IP address candidate created by the candidate creating portion 215 to the first communication interface 108.

[3. Process Executed by Information Processing Apparatus]

[3-1. Acquisition Process for Communication Address Information]

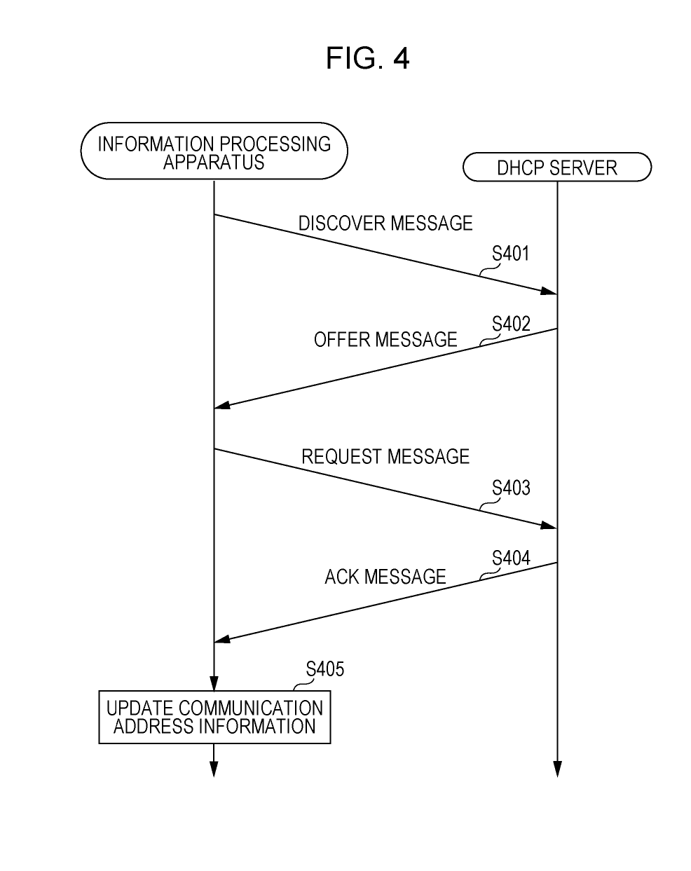

Next, a process to be performed by the information processing apparatus 100 will be described. FIG. 4 is a sequence diagram for describing a communication address acquisition process and an update process to be performed by the information processing apparatus 100. Here, as an example, the flow of a process will be described in the case where the information processing apparatus 100 acquires a piece of communication address information from a DHCP server. As illustrated in FIG. 4, first, the information processing apparatus 100 broadcasts, and sends a discover message to the entirety of a network segment to which a certain communication interface is connected (to a broadcast address) (S401). The discover message includes a MAC address of the certain communication interface.

In contrast, upon receiving the discover message, the DHCP server sends an offer message to the communication interface (S402). The offer message includes a piece of communication address information that may be used by the communication interface. That is, the offer message includes information of an IP address (an IP address that has not been leased to another computer or the like), information of the IP address of the DHCP server, information of a subnet mask, and information of a gateway. That is, the DHCP server presents an IP address that may be leased to the information processing apparatus 100.

Upon receiving the offer message, the information processing apparatus 100 acquires a piece of communication address information included in the offer message. Note that in the case where the information processing apparatus 100 has received plural offer messages, the information processing apparatus 100 acquires a piece of communication address information included in the offer message that has been received earliest. The information processing apparatus 100 sends a request message including the piece of acquired communication address information to the DHCP server (S403).

Upon receiving the request message, the DHCP server assigns an IP address to the information processing apparatus 100 in accordance with the content of the request message. The DHCP server limits use of the IP address assigned to the information processing apparatus 100 such that other computers are unable to use the IP address. Then, the DHCP server sends an ACK message indicating that the IP address has been officially assigned, to the information processing apparatus 100 (S404). When the information processing apparatus 100 receives the ACK message, the network setting information update unit 202 updates network setting information in accordance with a piece of communication address information included in the ACK message (S405).

Note that, in the above, the case has been described where the information processing apparatus 100 acquires a piece of communication address information using the DHCP function; however, the information processing apparatus 100 may also acquire a piece of communication address information in another method. For example, the information processing apparatus 100 may also acquire a piece of communication address information in accordance with an input done to the input unit 103 or the like.

[3-2. Setting Process for Communication Address Information]

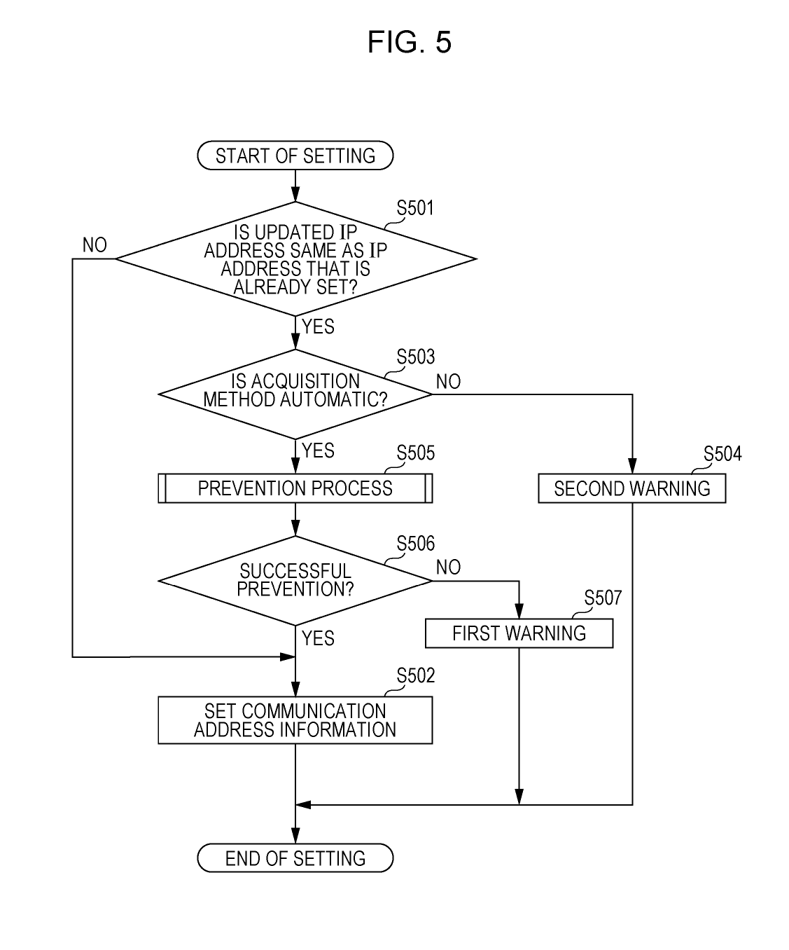

FIG. 5 is a flowchart illustrating a process in which the information processing apparatus 100 sets a piece of communication address information. The controller 101 executes the process illustrated in FIG. 5 in accordance with a program stored in the memory 104. This process is executed in the case where network setting information has been updated. By executing the process illustrated in FIG. 5, different communication addresses are assigned to respective communication interfaces illustrated in FIG. 1.

First, the duplication determination unit 204 determines whether or not an IP address included in a piece of updated communication address information is the same as an IP address included in another piece of communication address information (S501). When the duplication determination unit 204 determines that the IP addresses are not the same, the process proceeds to S502. When the duplication determination unit 204 determines that the IP addresses are the same, the process proceeds to S503.

In S501, when the duplication determination unit 204 determines that the IP addresses are not the same, the communication address information setting unit 203 sets the piece of acquired communication address information in a corresponding one of the communication interfaces (S502). Then, the information processing apparatus 100 ends the process in which a piece of communication address information is set.

In contrast, the case will be described where the duplication determination unit 204 determines in S501 that the IP addresses are the same. In this case, in the case where acquisition method information associated with the piece of updated communication address information indicates manual acquisition, the process proceeds to S504. In the case where the acquisition method information indicates automatic acquisition, the process proceeds to S505 (S503). In the case where the acquisition method information indicates manual acquisition, the second warning output portion 214 outputs a message indicating that the piece of communication address information is the same as another piece of communication address information that has already been set (S504). Then, the information processing apparatus 100 ends the process in which a piece of communication address information is set.

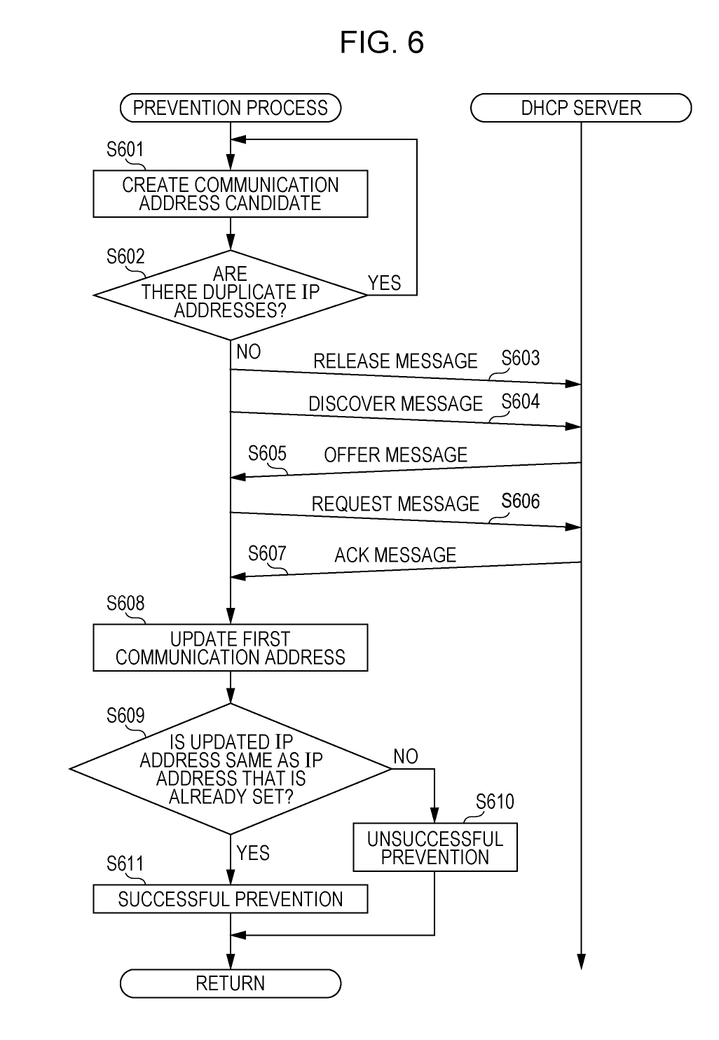

In contrast, in the case where the acquisition method information indicates automatic acquisition, the process proceeds to S505. Here, with reference to a flowchart illustrated in FIG. 6, an example of a prevention process of S505 will be described. FIG. 6 is a sequence diagram illustrating a sequence from when the information processing apparatus 100 releases an IP address that has been once leased from the DHCP server to when a piece of communication address information including a different IP address is acquired again from the DHCP server.

First, the candidate creating portion 215 creates an IP address candidate from IP addresses other than the IP address included in the piece of acquired communication address information (S601).

Next, the candidate determination portion 216 determines whether or not external devices 112 connected to the same network segment as a certain communication interface include an external device 112 in which the IP address candidate created by the candidate creating portion 215 is set (S602).

When it is determined in S602 that the external device 112 is included, the process proceeds to S601. In this case, the candidate creating portion 215 creates an IP address candidate again. That is, steps of S601 and S602 are repeatedly executed until an IP address candidate is created that differs from the IP addresses set in the external devices 112 connected to the same network segment as the certain communication interface. Note that in the case where the steps of S601 and S602 are repeatedly executed a preset number of times and an IP address is not created that differs from the IP addresses set in the external devices 112, the information processing apparatus 100 may end this process by considering that the sequence of the prevention process has failed.

In S602, when it is determined that the external device 112 is not included, the release requesting portion 217 sends a release message to the DHCP server having a DHCP function (S603). Upon receiving the release message, the DHCP server releases the IP address assigned to the certain communication interface.

Next, the creation requesting portion 218 sends a discover message including an IP address candidate created by the candidate creating portion 215 to the DHCP server in order to assign the IP address candidate to the certain communication interface (S604).

Upon receiving the discover message, the DHCP server sends an offer message to the certain communication interface (S605). Here, when the IP address candidate created by the candidate creating portion 215 may be leased, the DHCP server sends an offer message including the IP address. Note that the offer message does not have to include the IP address candidate created by the candidate creating portion 215. For example, in the case where the DHCP server is set to assign a predetermined IP address to a certain DHCP client, the DHCP server sends an offer message including the IP address, which is the same as the IP address that has been acquired before this process.

Next, the information processing apparatus 100 sends a request message including the piece of acquired communication address information to the DHCP server (S606). Upon receiving the request message, the DHCP server assigns an IP address to the information processing apparatus 100 in accordance with the content of the request message. The DHCP server limits use of the IP address assigned to the information processing apparatus 100 such that other computers are unable to use the IP address. Then, the DHCP server sends an ACK message indicating that the IP address has been officially assigned, to the information processing apparatus 100 (S607).

Next, the network setting information update unit 202 updates network setting information in accordance with the piece of acquired communication address information (S608). Then, similarly to as in S602, the duplication determination unit 204 determines whether or not information included in the piece of updated communication address information is the same as information included in another piece of communication address information (S609). When the duplication determination unit 204 determines that the information included in the piece of updated communication address information is the same as the information included in the other piece of communication address information, the information processing apparatus 100 ends this process by considering that the prevention process has failed (S610). In contrast, when the duplication determination unit 204 determines that the information included in the piece of updated communication address information is not the same as the information included in the other piece of communication address information, the information processing apparatus 100 ends this process by considering that the prevention process has succeeded (S611).

Here, the process returns to the flowchart illustrated in FIG. 5 and the description continues. When the prevention process fails in S505, the process proceeds to S507 (when No in S506). In this case, the first warning output portion 213 outputs a message indicating that the piece of communication address information is the same as another piece of communication address information that has already been set (S507). Then, the information processing apparatus 100 ends the process in which a piece of communication address information is set.

In contrast, when the prevention process succeeds in S505, the process proceeds to S502. In this case, a certain communication address information setting portion sets, in a certain communication interface, an IP address included in the piece of acquired communication address information acquired in the prevention process (S502), the certain communication interface corresponding to the IP address.

As described above, different communication addresses are assigned to respective communication interfaces in the information processing apparatus 100. Note that the exemplary embodiment is not limited to the above-described example and various modifications are permissible.

For example, the number of communication interfaces may be three or more. In this case, the information processing apparatus 100 may first determines whether or not a piece of acquired communication address information is the same as one or more communication addresses that have already been acquired, the piece of acquired communication address information being acquired at a later time than the one or more communication addresses. Then, the information processing apparatus 100 may execute the prevention process on the piece of acquired communication address information.

In addition, for example, according to the above-described example, for communication interfaces, pieces of communication address information corresponding to the communication interfaces are set in acquisition order; however, the information processing apparatus 100 may also set pieces of communication address information in accordance with the order of priority set for the communication interfaces. Specifically, for example, the information processing apparatus 100 may set likewise as described above a piece of communication address information in a communication interface having the highest priority among communication interfaces in which a piece of communication address information is not set. The information processing apparatus 100 repeatedly executes this setting method and as a result, pieces of communication address information are set for communication interfaces in order of decreasing priority starting from the communication interface having the highest priority.

The exemplary embodiment of the invention is not limited to the above-described example or modified examples and various modifications are permissible. The configuration of the information processing apparatus 100 and the flowcharts are mere examples, and are not limited to these examples.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquiring unit that acquires a first communication address to be assigned to a first communication interface;
a creating unit that creates, in a case where a second communication address that has already been assigned to a second communication interface is the same as the first communication address, an alternative first communication address, which is different from the first communication address; and
a requesting unit that requests assigning of the alternative first communication address to the first communication interface.

2. The information processing apparatus according to claim 1, wherein
the acquiring unit acquires at least one communication address together with the first communication address, and
the creating unit creates the alternative first communication address from communication address candidates other than the at least one communication address.

3. The information processing apparatus according to claim 1, wherein
the requesting unit requests release of the first communication address acquired by the acquiring unit.

4. The information processing apparatus according to claim 2, wherein
the requesting unit requests release of the first communication address acquired by the acquiring unit.

5. The information processing apparatus according to claim 1, further comprising:
a first warning output unit that outputs a first warning in response to a request from the requesting unit in a case where a communication address different from the second communication address is not assigned to the first communication interface.

6. The information processing apparatus according to claim 2, further comprising:
a first warning output unit that outputs a first warning in response to a request from the requesting unit in a case where a communication address different from the second communication address is not assigned to the first communication interface.

7. The information processing apparatus according to claim 3, further comprising:
a first warning output unit that outputs a first warning in response to a request from the requesting unit in a case where a communication address different from the second communication address is not assigned to the first communication interface.

8. The information processing apparatus according to claim 4, further comprising:
a first warning output unit that outputs a first warning in response to a request from the requesting unit in a case where a communication address different from the second communication address is not assigned to the first communication interface.

9. The information processing apparatus according to claim 1, further comprising:
an input unit to which the first or second communication address is input; and
a second warning output unit that outputs a second warning in a case where the second communication address that has already been assigned to the second communication interface matches a communication address input to the input unit and to be assigned to the first communication interface.

10. The information processing apparatus according to claim 2, further comprising:
an input unit to which the first or second communication address is input; and
a second warning output unit that outputs a second warning in a case where the second communication address that has already been assigned to the second communication interface matches a communication address input to the input unit and to be assigned to the first communication interface.

11. The information processing apparatus according to claim 3, further comprising:
an input unit to which the first or second communication address is input; and
a second warning output unit that outputs a second warning in a case where the second communication address that has already been assigned to the second communication interface matches a communication address input to the input unit and to be assigned to the first communication interface.

12. The information processing apparatus according to claim 4, further comprising:
an input unit to which the first or second communication address is input; and
a second warning output unit that outputs a second warning in a case where the second communication address that has already been assigned to the second communication interface matches a communication address input to the input unit and to be assigned to the first communication interface.

13. An information processing method comprising:
acquiring a first communication address to be assigned to a first communication interface;
creating, in a case where a second communication address that has already been assigned to a second communication interface is the same as the first communication address, an alternative first communication address, which is different from the first communication address; and
requesting assigning of the alternative first communication address to the first communication interface.

14. A non-transitory computer readable medium storing a program causing a computer to execute a process, the process comprising:
acquiring a first communication address to be assigned to a first communication interface;
creating, in a case where a second communication address that has already been assigned to a second communication interface is the same as the first communication address, an alternative first communication address, which is different from the first communication address; and
requesting assigning of the alternative first communication address to the first communication interface.
